(19) United States
(12) Patent Application Publication
(10) Pub. No.: US 2015/0006211 A1
(43) Pub. Date: Jan. 1, 2015

(54) RESOURCE PLANNING

(71) Applicants: Cipriano A. Santos, Modesto, CA (US); Maria Teresa Gonzalez Diaz, Mountain View, CA (US); Juan Antonio Orozco Guzman, Guadalajara (MX); Marcos Cesar Vargas-Magana, San Pedro Zacatenco (MX); Ivan Lopez- Sanchez, Hermosillo (MX); Carlos Enrique Valencia Olefa, Tlalpan (MX); Lyle H. Ramshaw, Palo Alto, CA (US); Robert E. Tarjan, Princeton, NJ (US); Shailendra K. Jain, Cupertino, CA (US)

(72) Inventors: Cipriano A. Santos, Modesto, CA (US); Maria Teresa Gonzalez Diaz, Mountain View, CA (US); Juan Antonio Orozco Guzman, Guadalajara (MX); Marcos Cesar Vargas-Magana, San Pedro Zacatenco (MX); Ivan Lopez- Sanchez, Hermosillo (MX); Carlos Enrique Valencia Olefa, Tlalpan (MX); Lyle H. Ramshaw, Palo Alto, CA (US); Robert E. Tarjan, Princeton, NJ (US); Shailendra K. Jain, Cupertino, CA (US)

(21) Appl. No.: 14/374,828

(22) PCT Filed: Apr. 26, 2012
(86) PCT No.: PCT/US2012/035180

§ 371 Date: Jul. 25, 2014

(51) Int. Cl. G06Q 10/06

(52) U.S. Cl. CPC G06Q 10/0631
USPC 705/7.12

(57) ABSTRACT

Methods, systems, and computer-readable and executable instructions are provided for resource planning. Resource planning can include identifying a resource capacity for a given resource planning horizon, identifying a resource pool guideline that defines a priority of resources from which to satisfy a full-time equivalent (FTE) resource planning requirement, and performing resource planning by satisfying the FTE requirement based on the resource capacity and the resource pool guideline.

### BACKGROUND

Service organizations employ service professionals to deliver a variety of services to customers and use workforce planning to allocate workforce resources. During workforce planning, service organizations consider a number of objectives including increasing billable utilization of the work force, reducing overall labor costs, and matching job requirements with employee qualifications.

### BRIEF DESCRIPTION OF THE DRAWINGS

FIG. 1 is a block diagram illustrating an example of a method for resource planning according to the present disclosure.

FIG. 2 is a block diagram illustrating an example of a method for resource planning according to the present disclosure.

FIG. 3 is a block diagram illustrating a processing resource, a memory resource, and computer-readable medium according to the present disclosure.

### DETAILED DESCRIPTION

Examples of the present disclosure may include methods, systems, and computer-readable and executable instructions and/or logic. An example method for resource planning can include identifying a resource capacity for a given resource planning horizon, identifying a resource pool guideline that defines a priority of resources from which to satisfy a full-time equivalent (FTE) resource planning requirement, and performing resource planning by satisfying the FTE requirement based on the resource capacity and the resource pool guideline.

A full time equivalent (FTE) can include a certain portion of a full time assignment according to customs in the geographic location of the resource. For example, in some locations, a workweek may be defined as having 40 hours per week, while other locations may define a workweek as 37 hours per week. An FTE of 1 can indicate a full time resource, and an FTE of 0.5 can indicate half of a full time resource (needed or provided), for example.

Workforce planning can include providing workforce resources with the right skills for the right job at the right time at the right cost. Resource planning can allow for efficient identification and prevention of current and future gaps between an available workforce and a workforce that can be used to deliver a project. Resource planning can also allow for satisfaction of FTE requirements of positions, while considering fractional resource capacity and resource pools guidelines (RPG), as discussed further herein.

Resource planning and/or FTE requirements may only allow one employee allocated to at most one job. In order to increase resource utilization, FTE requirements can be satisfied (e.g., “solved”) several times (e.g., iteratively) until all FTE jobs requirements are satisfied and/or there is no remaining capacity for qualified employees to fill remaining gaps. The FTE requirements can be solved by mathematical optimization solvers such as, for example, gurobi optimization and/or other specialized methods that solve the assignment problem.

As used herein, an organization may be a business entity, but need not be limited to an entity having a commercial intent. Resources can refer to human and non-human resources, such as people, equipment, buildings, vehicles, services, assets, and the like. For example, resources may include employees, computer processing capability at a particular time or over some period of time (e.g., resource planning horizon), data storage hardware, and/or office space used by an organization, among others. As such, resource planning can include workforce planning.

As used herein, a job can include any function to which a resource can be assigned. For example, a job can be an employment situation, such as a professional services position that may be associated with a business entity or project associated with the business entity. A job can also be a task performed by an apparatus. For example, a job can be data storage performed by a storage device (e.g., memory), or a job can be a batch processing performed by one or more processors.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P,” “R”, and “S” particularly with respect to reference numerals in the drawings, indicate that a number of the particular feature so designated can be included with a number of examples of the present disclosure. Also, as used herein, “a number of” an element and/or feature can refer to one or more of such elements and/or features.

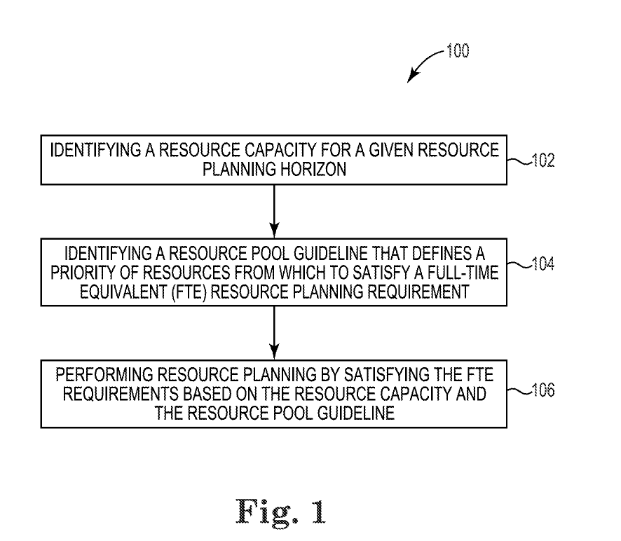

FIG. 1 is a block diagram illustrating an example of a method 100 for resource planning according to the present disclosure. At 102, a resource capacity for a given resource planning horizon is identified. A resource capacity can include resource(s) available over the planning horizon and can include information describing an FTE capacity of various resources available during the planning horizon. A resource capacity can include an available resource capacity for a particular resource, for example. The identification cart be performed by a computing device (e.g., a computer). For example, resource capacity can be identified via user input, it can be pulled from a computer database, and/or it can be identified through data mining, among others.

At 104, an RPG that defines a priority of resources from which to satisfy an FTE resource planning requirement is identified, and resource planning can be performed at 106 by satisfying the FTE requirement based on the resource capacity and the RPG. RPGs can be represented by a table with a prioritized list of resource pools for each job requirement. For example, if a customer in the USA implements an application (e.g., an application supervised by a specialized engineer), the RPG for the project can dictate, for example, that the primary resource pool is in the USA, the secondary resource pool is in Mexico, and the tertiary resource pool is in India. In an example, the application is an information technology project, but is not so limited.

These RPGs and their priority can be determined based on a company's preference, cost of working with a particular resource pool, resource availability, contract obligations, resource pool location, and/or resource pool association with a particular business unit, among others. The RPG identification can be performed by a computing device (e.g., a computer). For example, an RPG can be identified via user input, it can be pulled from a computer database, and/or it can be identified through data mining, among others.

Resource planning that considers the RPGs may first look for resources in the USA to fill the FTE job requirements of this project, and if there are gaps remaining, resources in Mexico can be considered to fill remaining gaps. If there are gaps that cannot be filled with Mexican resources, then the approach tries to fill these gaps with resources in India. If there are remaining gaps that cannot be filled with Indian resources, then the approach may try to hire new resources. The hiring process can also follow the RPGs. Resource planning, as described further herein, can satisfy FTE requirements at each iteration of the search for resources to fill project FTE requirements.

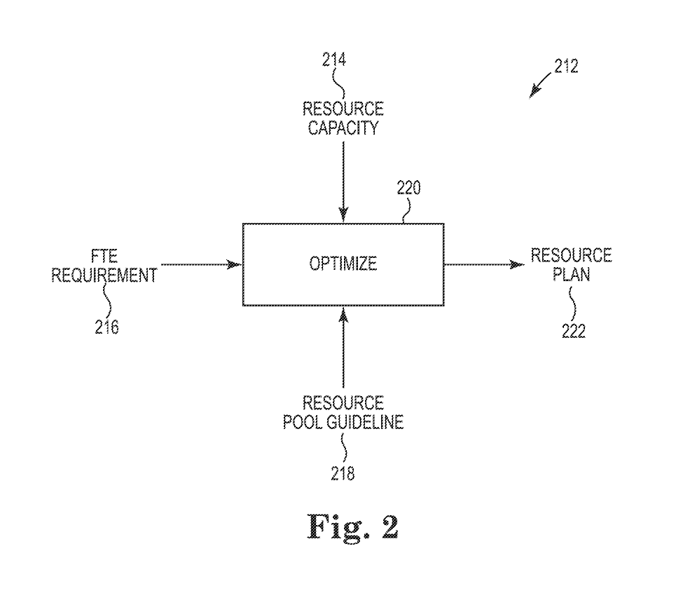

FIG. 2 is a block diagram illustrating an example of a method 212 for resource planning according to the present disclosure. A mathematical optimization model (e.g., a function) can be solved a number of times at 220 in order to address the FTE job requirements and the resource capacity (e.g., fractional resource capacity) available. For example, a resource capacity can be considered at 214, an FTE job requirement can be considered at 216, and a resource pool guideline can be considered at 218. For the mathematical optimization model, it can be assumed that the FTE job requirement is defined as a one employee capacity requirement. If the FTE job requirement is one, it can require one resource working on the job 100 percent of her/his capacity; whereas if the FTE job requirement is fractional, it can require one resource working on the job at less than 100 percent of her/his capacity. In a fractional situation, the resource may be allocated to other jobs with the leftover capacity available.

An objective function of the mathematical optimization model can capture a number of optimization objectives and/or allocation business rules. For example, a project delivery manager may express his or her preference for an employee to fill a certain type of job (e.g., pre-allocation preference), and in an example, such pre-allocation preferences can be honored as long as the allocation is not sub-optimal with respect to other optimization objectives.

Allocating the most qualified employee to a particular FTE job requirement may be an optimization objective. For example, a matching score that defines an employee's ability (e.g., qualifications) to perform a particular task can be computed between job requirements and employee qualifications. Another optimization objective, for example, may be a capacity availability of resources. A resource can be allocated to a job with the resource capacity available exactly matching the FTE job requirement to avoid a shortage of capacity or idle capacity. A deviation of the resource capacity allocated with respect to the FTE job requirement can be measured, and total deviations can be optimized. In an example, a particular job may be considered more important than another job. For example, a particular project and/or job may result a higher revenue and profit than another project, and other projects may have strategic value for a company. The objective function of the mathematical optimization model can capture this priority of projects, for example.

The objective function of the mathematical optimization model can have a weighting factor for a maximization of the matching score and a weighting factor for a minimization of deviation of the resource capacity allocated with respect to the FTE job requirement. The weighting factors can be determined by a user, for example, and these weighting factors can reflect an importance of one objective with respect to another. The weighting factors can be normalized as numbers between zero and one in such a way that the sum of the factors is exactly one, for example.

In an example, rather than a user determining the weighting factors, the mathematical optimization approach can automatically construct a Pareto (e.g., optimal trade-off) of the two objectives by varying one of the factors from zero to one, with particular increments (e.g., 0.10). For each combination of weighting factors, the mathematical optimization approach can generate an optimal allocation plan and a metric can be reported. For example, reported metrics can include a global demand fulfillment metric, a global resource utilization metric, a total matching scores, and a total available capacity utilization. In an example, a user can choose an allocation plan based on the metric(s) reported.

A resource planning FTE assignment model can have a number of constraints. For example, the model can include demand constraints and resource constraints. For each job requirement, the demand constraints can identify a qualified resource and/or declare a gap for that job. For each resource, the resource constraint can identify the set of jobs that the resource is qualified for and/or allocate at most one job to such resource, for example.

As previously discussed herein, the resource planning FTE assignment model can be solved a number of times. It can be solved to maximize resource utilization at each Resource Pool, and it can be solved moving from a preferred Resource Pool to a less preferred Resource Pool, as dictated by the RPGs, until all remaining gaps are zero or all qualified resources have been exhausted. However, it is possible that there are remaining gaps while all resources have been exhausted, and in this case, an assignment problem can be formulated for hiring, called a resource planning hiring assignment model. The resource planning hiring assignment model can fill remaining gaps with new employees hired. In the resource planning hiring assignment model, it can be assumed that a new employee is fully qualified for the required job, and it can be assumed that an employee hired is allocated to only one job. The resource planning hiring assignment model can consider a maximum number of employees that can be hired and hiring lead time by job. An objective function of the resource planning hiring assignment model may, for example, only consider optimization of the matching score and the priority of the projects.

The mathematical optimization formula of the resource planning FTE assignment model can include a number of indices. For example, wεW can include an index and set of employees, jεJ can include an index and set of jobs, iεI can include an index and set of project opportunities, and sεS can include an index and set of positions. A job requirement can be split into a number of positions, where each position of the job is assumed to be filled by one employee at the FTE required capacity.

An index and set of time periods (e.g., planning horizon) can include tεT, and jisεJIS can include an index referring to a position s of job j required by project l and can be referred to as a “position,” where JIS is a set of such valid indices.

A set of feasible allocations of employee w to position jis, where wjis is an index referring to employee w and position jis can be referred to as alloc_{wjis}, and latealloc_{wjis} can include a set of potential allocations that can have partial gaps at a number of time periods of the planning horizon. A set of pre-allocation preferences for resource w filling position jis can be referred to as prealloc_{wjis}.

Input parameters of the resource planning FTE assignment model can include, for example, K_{w,t}, REQ_{jis,t}, cms_{w,j,i}, and cav_{w,j,i,s}. K_{w,t} can include a fractional capacity available of employee w at period t. In an example, whenever the employee is fully available the capacity available is 1. REQ_{jis,t} can include an FTE (fractional) requirement of resource capacity for position jis at period t. In an example, whenever a resource filling a position jis at period t is required full time, then the FTE requirement is 1.

In a number of embodiments, cms_{w,j,i} can include a mismatching penalty for allocating a non-fully qualified resource w to job ji, and this penalty can also be interpreted as a deviation of an allocation with respect to a 100 percent matching. For example, if ms_{w,j,i} is the matching score of resource w with respect to job ji, then the mismatching penalty can be calculated as follows:

cms_{w,j,i}=(1−ms_{w,j,i})*mspen.

In the above example, whenever employee w is fully qualified for job ji, then the matching score is 1, and the allocation penalty is zero. The parameter mspen can be a user configurable parameter to reflect an importance of the matching score objective.

A capacity penalty for either over or under capacity allocation of employee w to position jis can be cav_{w,j,i,s}. For example, the capacity penalty can be computed as follows:

$${cav}_{w , jis} = capover * {\sum }_{t ∈ T} ( ( T - t + 1 ) * max ( 0 , {K}_{w , t} - {REQ}_{jis , t} ) ) + capunder * {\sum }_{t ∈ T} ( ( T - t + 1 ) * min ( 0 , {K}_{w , t} - {REQ}_{jis ,} t ) ) .$$

Capover and capunder can include user configurable parameters to reflect an importance of having idle capacity (e.g., capover) or shortage capacity (e.g., capunder). In an example, it is desired that an employee have a minimum capacity available in order to be able to perform a required job, and a minimum capacity requirement (e.g., a threshold) can be expressed as a percentage, for example. A parameter alloc_{wjis} can be used to reflect this as follows:

(w,jis)εalloc if and only if K_{w,t}−REQ_{jis,t}≧threshold*REQ_{jis,t}−REQ_{jis,t}∀tεT.

For example, if it is assumed that a REQ=0.8 and a threshold=0.9, then an employee has enough available capacity if K is greater or equal than 0.72.

A benefit of honoring pre-allocation preferences can be referred to as papref, and revloss_{j,i} can define a penalty for leaving job ji un-filled at a particular time period. In an example, these penalties can reflect a priority of project i. A start time period for position jis can include stⱼᵢₛ, and durⱼᵢₛ can include a duration of position jis requirements. It can be assumed, for example, that as soon as job starts, it will continue without interruption until it finishes. A number of periods before resource w is available can be referred to as notavail_{w}.

Decision variables can include, for example, u_{w,jis}ε{0,1} being 1 if employee w is allocated to position jis and 0 otherwise and gapⱼᵢₛε{0,1} being 1 if FTE requirement of position jis cannot be filled with current employees and 0 otherwise.

An objective function of the resource planning FTE assignment model can entail minimizing total penalties associated to allocating an employee to a job that is not 100 percent qualified, total penalties associated with the deviation of the employee capacity allocated with respect to the FTE job requirements, and total penalty of gaps, where these penalties reflect project priority. In addition, the objective function can have an incentive of respecting pre-allocations preferences. For example:

$$Min Penalties = - papref * {\sum }_{wjis ∈ prealloc ( wjis )} {u}_{wjis} + {\sum }_{wjisealloc ( wjis )} ( {cms}_{wjis} + {cav}_{wjis} ) * {u}_{wjis} + {\sum }_{wjis ∈ latealloc ( wjis )} min ( {dur}_{jis} , {notavail}_{w} - {st}_{jis} + 1 ) * {revloss}_{ji} * {u}_{wjis} + {\sum }_{jis ∈ JIS} {dur}_{jis} * {revloss}_{ji} * {gap}_{jis}$$

The demand constraint can ensure that either a position requirement is filled by a resource or that a gap is declared. For each (j,i,s)εJIS, the following can be satisfied:

$${\sum }_{w ∈ alloc ( w , jis )} {u}_{w , jis} + {gap}_{jis} = 1.$$

The resource constraint can ensure that each employee is at most allocated to one position. For each wεW, the following can be satisfied:

$${\sum }_{jis ∈ JIS} {u}_{w , jis} \leq 1.$$

To solve the resource planning FTE assignment model, employees can be allocated with fractional capacity to FTE position requirements. A series of resource planning FTE assignment models can be solved. For example, it can be assumed that each position requirement has a hierarchy or priority pool. A priority pool can include a list of resource pools defined for each position requirement, where the first resource pool in the list (e.g., a primary resource pool) is the first resource pool from which resources can be considered to fill the FTE requirements of the position. After all possible resources in the primary resource pool have been considered to fill requirements of positions, if there are remaining gaps, the second resource pool in the list (e.g., a secondary resource pool) is considered. This allocation can continue until either all resources in the positions' priority pool have been exhausted or there are no remaining gaps, for example.

In an example, each time that a resource planning FTE assignment model is solved, allocation decisions can be fixed, and remaining employee capacity can be computed. It can be computed as a difference between the employee capacity (e.g., prior to solving the current instance of the resource planning FTE assignment model) and the total employee capacity allocated after solving the current instance of the resource planning FTE assignment model. If there are remaining gaps and there is employees' capacity to fill demand, a new instance of the resource planning FTE assignment model is generated with the remaining employee capacity as the initial employee capacity, and the remaining gaps as the demand.

In some embodiments, optimal trade-offs between maximizing total matching scores and minimizing total deviations of capacity allocations can be calculated. For example, a problem P^{ms} (e.g., a resource planning FTE assignment model) can be solved, maximizing the total matching score without considering the capacity availability objective. For example, a P^{ms} objective formulation can include:

$$Min Penalties = - papref * {\sum }_{wjis ∈ prealloc ( wjis )} {u}_{wjis}^{m s} + {\sum }_{wjis ∈ alloc ( wjis )} {cms}_{wjis} * {u}_{{wjis}^{mx}} + {\sum }_{wjis ∈ latealloc ( wjis )} min ( {dur}_{jis} , {notavail}_{w} - {st}_{jis} + 1 ) * {revloss}_{ji} * {u}_{wjis}^{m s} + {\sum }_{jis ∈ JIS} {dur}_{jis} * {revloss}_{ji} * {gap}_{jis}^{m s} .$$

A demand constraint can be considered, and for each (j,i,s)εJIS, the following can be satisfied:

$${\sum }_{w ∈ alloc ( w , jis )} {u}_{w , jis}^{m s} + {gap}_{jis}^{m s} = 1.$$

A resource constraint can be considered, and for each wεW, the following can be satisfied:

$${\sum }_{jis ∈ JIS} {u}_{w , jis}^{m s} \leq 1.$$

Minimizing the penalties cms_{wjis} can be equivalent to maximizing the matching scores ms_{wjis}. The optimal total matching score can defined as follows:

$${MS}^{opt} = {\sum }_{wjis ∈ alloc}^{ } {ms}_{wjis}$$

where ū_{wjis}^{ms}, wjisεalloc(wjis) is the optimal solution of P^{ms}.

In an example, the optimal total matching score has an upper bound of |JIS| (e.g., resources were found that are matching for all the positions). That is,

MS^{opt}≦|JIS|.

A parameter αε[0,1] can be considered as a relaxation of the optimal matching score. Values of α can be discretized: α0=0.0, α1=0.1, α2=0.2 . . . α10=1.0, for example.

Problem Pₐ can be solved for a=0, 1, 2 . . . 10, where a corresponds to the values of α (e.g., if a=3, then the problem P₃ considers α3=0.3). For example, the Pₐ formulation can include an objective function:

$$Min Penalties = - papref * {\sum }_{wjis ∈ prealloc ( wjis )}^{ } {u}_{wjis}^{a} + {\sum }_{wjis ∈ alloc ( wjis )}^{ } {cav}_{wjis} * {u}_{wjis}^{a} + {\sum }_{wjis ∈ latealloc ( wjis )}^{ } min ( {dur}_{jis} , {notavail}_{w} - {st}_{jis} + 1 ) * {revloss}_{ji} * {u}_{wjis}^{a} + {\sum }_{jis ∈ JIS}^{ } {dur}_{jis} * {revloss}_{ji} * {gap}_{jis}^{a} .$$

A demand constraint can be considered, where for each (j,i,s)εJIS, the following can be satisfied:

$${\sum }_{w ∈ alloc ( w , jis )}^{ } {u}_{w , jis}^{a} + {gap}_{jis}^{a} = 1.$$

A resource constraint can be considered, where for each 0, wεW, the following can be satisfied:

$${\sum }_{jis ∈ JIS}^{ } {u}_{w , jis}^{a} \leq 1.$$

A Pareto constraint can ensure that the total matching score is at least a percentage of the optimal total matching score. For example,

$${\sum }_{wjis ∈ alloc ( wjis )}^{ } {ms}_{wjis} * {u}_{wjis}^{a} \geq {α}_{a} * {MS}^{opt} .$$

In an example, P₀ corresponds with P^{ms}, which has been previously defined.

Metrics can be considered to evaluate each of the optimal employee allocations of the Pareto (e.g., for each value of alpha). It can be assume the vector u is the optimal allocation of employees to positions after solving problem Pₐ.

A global demand fulfillment metric can be defined as a ratio of a number of positions fulfilled with respect to a total number of positions required. The optimal value of this metric can be 1, which means that all positions requirements are satisfied completely. In an example, the number of positions filled is equal to the total number of positions required minus the number of positions that could not be filled at all; the global demand fulfillment metric can defined as follows:

$$HCdemful = ( 1 - \frac{{\sum }_{jis}^{ } {gap}_{jis}}{{\sum }_{jis}^{ } {1}_{jis}} ) .$$

This metric may not consider partial gaps derived from an employee capacity availability happening some periods after the start time of the position.

A global resource utilization metric can be defined as a ratio between the employees allocated to fill demand requirements with respect to the total number of employees. The optimal value of this metric can be 1, meaning all employees can be allocated to fill positions requirements. For example, an employee w can be idle if he or she was not allocated to fill any position (e.g.,

$${\sum }_{jis}^{ } {u}_{w , jis} = 0 ) .$$

A set of idle employees can include:

$$IDLE = \{ w ∈ W \text{:} {\sum }_{jis ∈ JIS}^{ } {u}_{u , jis} = 0 \} ,$$

and as a result, the number of employees allocated to fill positions requirements can be equal to the total of number employees minus the total number of employees that are idle. The global resource utilization metric can be computed as follows:

$$HCresutil = ( 1 - \frac{{\sum }_{w ∈ IDLE}^{ } {1}_{w}}{{\sum }_{w ∈ W}^{ } {1}_{w}} ) .$$

A global matching score metric can be defined as a ratio of the total matching scores of employees allocated to fill positions with respect to a matching, (e.g., “perfect” matching) for all positions required. The optimal value of this metric can be 1, meaning that all positions can be filled with matching, (e.g., perfect matching) employees. The global matching score metric can be computed as follows:

$$MSdemful = ( \frac{{\sum }_{( w , jis ) ∈ alloc ( wjis )}^{ } {ms}_{w , ji} * {u}_{w , jis}}{{\sum }_{jis}^{ } {1}_{jis}} ) .$$

A total available capacity utilization metric can be defined as a ratio of total capacity allocated with respect to total capacity available. It can be assumed that if employee w is allocated to position jis, the employee capacity allocated at each period of time can equal the FTE position requirement at each period (e.g., the allocated capacity of employee w is (REQ_{jis,t})_{tεT}). The optimal value of this metric can be 1, meaning that all employees' available capacity can be allocated to fill demand. The total available capacity utilization can be computed as follows:

$$capresutil = ( \frac{{\sum }_{( w , jis ) ∈ alloc ( wjis )}^{ } {u}_{w , jis} * {\sum }_{t ∈ T}^{ } {REQ}_{jis , t}}{{\sum }_{( w , t ) ∈ WT}^{ } {K}_{w , t}} ) .$$

A mathematical optimization formulation of a resource planning hiring assignment model can include a number of indices. For example, hεH can include an index and set of hiring positions. This index can be defined by a region g and hiring ID number n. That is, h=(g, n) where gεG is the index and set of the regions.

An index and set of jobs can include jεJ, IεI can include an index and set of project opportunities, sεS can include an index and set of positions, and tεT can include an index and set of time periods (e.g., a planning horizon).

An index referring to position s of job j required by project i (e.g., a position) can include jisεJIS, with JIS being a set of such valid indices. A set of feasible allocation of new hire h to position jis can include allochr_{h,jis}, and a set of potential allocations of new hires that may have partial gaps at some time periods of the planning horizon can include lateallochr_{h,jis}, for example.

Input parameters of the resource planning hiring assignment model can include a number of parameters. K_{h,t} can include a capacity available of new hire h at period t. In an example, the new hire can be full time with capacity 1, or the new hire may be part time with a capacity of less than 1.

In a number of embodiments, parameter REQ_{jis,t} can include an FTE (fractional) requirement of resource capacity for position jis at period t. In an example, whenever a resource to fill position jis at period t is required full time, then the FTE requirement is 1, and this position requirement can correspond to remaining gaps.

Parameter cavhr_{h,j,t,s} can include a capacity penalty for either over or under capacity allocation of new hire h to position jis. The capacity penalty can be computed as follows:

$${cavhr}_{h , jis} = capover * {\sum }_{t ∈ T}^{ } ( ( T - t + 1 ) * max ( 0 , {K}_{h , t} - {REQ}_{jis , t} ) ) + capunder * {\sum }_{t ∈ T}^{ } ( ( T - t + 1 ) * min ( 0 , {K}_{h , t} - {REQ}_{jis} , t ) ) .$$

Parameter revloss_{j,i} can include a penalty for leaving job ji un-filled at a particular time period, and the penalty can reflect a priority of project i. A start time period for position jis can include stⱼᵢₛ, and durⱼᵢₛ can include a duration of position jis requirements. It can be assumed that as soon as job starts, it will continue without interruption until it finishes. Parameter hlt_{g,j} can include a hiring lead time for job j at region G, for example.

A number of decision variables can be considered. For example, uhr_{h,jis}ε{0,1} can be 1 if new hire h is allocated to position jis, and 0 otherwise. Further, gaphrⱼᵢₛε{0,1} can indicate if a remaining gap for position jis cannot be filled by a new hire.

An objective function of the resource planning hiring assignment model can include minimizing total penalties associated with deviation of the new hire capacity allocated with respect to the FTE job requirements and the total penalty of gaps, where these penalties reflect project priority. For example,

$$Min Penalties = {\sum }_{( h , jis ) ∈ allochr ( h , jis )}^{ } {cav}_{h , jis} * {uhr}_{h , jis} + {\sum }_{( g , n , j , i , s ) ∈ lateallochr ( g , n , j , i , s )}^{ } min ( {dur}_{jis} , {hlt}_{g , j} - {st}_{jis} + 1 ) * {revloss}_{ji} * {uhr}_{g , n , jis} + {\sum }_{jis ∈ JIS}^{ } {dur}_{jis} * {revloss}_{ji} * {gaphr}_{jis}$$

A demand constraint can be considered, and it can ensure that either a position requirement is filled by a new hire, or that a gap is declared. For each (j,i,s)εJIS, the following can be satisfied:

$${\sum }_{h ∈ alloc ( h , jis )}^{ } {uhr}_{h , jis} + {gaphr}_{jis} = 1.$$

A resource constraint can be considered, and it can ensure that each new hire is at most allocated to one position. For each hεH, the following can be satisfied:

$${\sum }_{jis ∈ JIS}^{ } {uhr}_{h , jis} \leq 1.$$

A resource plan can result at 222. The plan can be used to provide workforce resources with desired skills for the appropriate job at the appropriate time and cost.

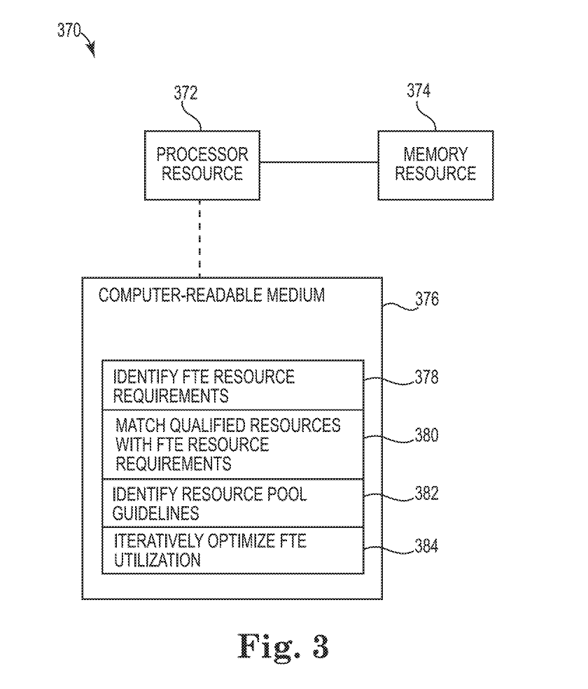

FIG. 3 is a block diagram 370 illustrating a processor resource 372, a memory resource 374, and a computer-readable medium 376 according to the present disclosure. The computer-readable medium (CRM) 376 (e.g., a tangible, non-transitory medium) and/or the memory resource 374 can store a set of instructions executable by the processor resource to identify a number of FTE resource requirements for resource planning at 378, and match a number of qualified resources with the number of FTE resource requirements at 380.

The instructions can be executed at 382 to identify a number of resource pools guidelines that define a priority of each of a number of resource pools, the number of resource pools including the number of qualified resources and iteratively optimize FTE utilization at each of the number of resource pools based on the priority of each of the number of resource pools at 384. 14. The number of resource pools guidelines can include, for example, a table with a prioritized list of resource pools for each FTE resource requirement.

In some examples of the present disclosure, the instructions can be further executed to assign a matching score to the number of qualified resources and the number of FTE resource requirements and/or iteratively optimize FTE utilization until either each of the number of FTE requirements is satisfied or there is no remaining capacity for qualified employees to fill remaining gaps. The instructions can be executed to iteratively optimize FTE utilization with respect to at least one of a demand constraint and a resource constraint.

In some examples of the present disclosure, the instructions can be executed to iteratively satisfy a number of FTE requirements based on a number of fractional resource capacities and a number of resource pools guidelines and optimize the satisfying based on a deviation of the number of fractional resource capacities allocated with respect to the number of FTE requirements. The instructions can be further executable to iteratively satisfy the number of FTE requirements until at least one of each of the number of FTE requirements is satisfied and there is no remaining capacity for a qualified employee to fill a remaining FTE requirement gap. The instructions can be executed to fill the remaining FTE requirement gap with a new hire and optimize the satisfying using a mathematical optimization solver.

The methods, techniques, systems, and apparatuses described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

What is claimed:

1. A computer-implemented method for resource planning, comprising:
identifying a resource capacity for a given resource planning horizon;
identifying a resource pool guideline that defines a priority of resources from which to satisfy a full-time equivalent (FTE) resource planning requirement; and
performing resource planning by satisfying the FTE requirement based on the resource capacity and the resource pool guideline
wherein the method is performed by a computing device.

2. The method of claim 1, further including optimizing a trade-off between resource qualification and resource availability.

3. The method of claim 2, wherein optimizing the trade-off includes computing a matching score that defines an employee's ability to perform a particular task.

4. The method of claim 2, wherein optimizing the trade-off includes computing a capacity allocation that defines the employee's available performance capacity.

5. The method of claim 1, wherein the resource capacity includes a fractional resource capacity.

6. The method of claim 2, wherein optimizing the trade-off includes optimizing the trade-off with respect to a global demand fulfillment metric, a global resource utilization metric, a global matching score metric, and a total available capacity utilization metric.

7. A non-transitory computer-readable medium storing a set of instructions executable by a processing resource to:
iteratively satisfy a number of full time equivalent (FTE) requirements based on a number of fractional resource capacities and a number of resource pools guidelines; and
optimize the satisfying based on a deviation of the number of fractional resource capacities allocated with respect to the number of FTE requirements.

8. The non-transitory computer-readable medium of claim 7, wherein the instructions are further executable to iteratively satisfy the number of FTE requirements until at least one of each of the number of FTE requirements is satisfied and there is no remaining capacity for a qualified employee to fill a remaining FTE requirement gap.

9. The non-transitory computer-readable medium of claim 8, wherein the instructions are further executable to fill the remaining FTE requirement gap utilizing a resource planning hiring assignment model.

10. The non-transitory computer-readable medium of claim 8, wherein the instructions are further executable to optimize the satisfying using a mathematical optimization solver.

11. A system for resource planning, comprising:
a memory resource; and
a processing resource coupled to the memory resource, to:
identify a number of full time equivalent (FTE) resource requirements for resource planning;
match a number of qualified resources with the number of FTE resource requirements;
identify a number of resource pools guidelines that define a priority of each of a number of resource pools, the number of resource pools including the number of qualified resources; and
iteratively optimize FTE utilization at each of the number of resource pools based on the priority of each of the number of resource pools.

12. The system of claim 11, wherein the processing resource is further coupled to the memory resource to assign a matching score to the number of qualified resources and the number of FTE resource requirements.

13. The system of claim 11, wherein the processing resource is further coupled to the memory resource to iteratively optimize FTE utilization until either each of the number of FTE requirements is satisfied or there is no remaining capacity for qualified employees to fill remaining gaps.

14. The system of claim 11, wherein the number of resource pools guidelines includes a table with a prioritized list of resource pools for each FTE resource requirement.

15. The system of claim 11, wherein the processing resource is further coupled to the memory resource to iteratively optimize FTE utilization with respect to at least one of a demand constraint and a resource constraint.
